(19) United States
(12) Patent Application Publication
(10) Pub. No.: US 2013/0294619 A1
(43) Pub. Date: Nov. 7, 2013

(54) Engine Sound Enhancement ("ESE") System for a Continuously Variable Transmission ("CVT") Equipped Vehicle

(71) Applicants: Frank C. Valeri, Novi, MI (US); Scott M. Reilly, Southfield, MI (US)

(72) Inventors: Frank C. Valeri, Novi, MI (US); Scott M. Reilly, Southfield, MI (US)

(73) Assignee: GM GLOBAL TECHNOLOGY OPERATIONS LLC

(21) Appl. No.: 13/461,868

(22) Filed: May 2, 2012

(51) Int. Cl. H04B 1/00

(52) U.S. Cl. 381/86

(57) ABSTRACT

A control system for a vehicle is provided. The vehicle has a continuously variable transmission (“CVT”), an engine, and a speaker. The control system includes a vehicle bus, a shifting module, and an engine sound module. The vehicle bus transmits a signal. The signal indicates a plurality of operating conditions of the vehicle. The shifting module receives the signal from the vehicle bus. The shifting module determines if the plurality of operating parameters of the vehicle indicate that the speaker is required to emit an audio signal that is blended with an engine sound emitted from the engine to mimic a shifting sound that a theoretical fixed gear transmission creates while shifting gears. The shifting module generates a shift mode signal if the speaker is required to emit the audio signal. The engine sound enhancement (“ESE”) module receives the shift mode signal.

### FIELD OF THE INVENTION

Exemplary embodiments of the invention relate to a control system for a vehicle and, more particularly, to a control system providing engine sound enhancement for a vehicle having a continuously variable transmission (“CVT”).

### BACKGROUND

A continuously variable transmission (“CVT”) provides greater efficiency when compared to fixed gear ratio transmissions. Greater efficiency results in improved fuel economy. However, some individuals prefer the sound quality and feel of a fixed gear transmission rather than a CVT transmission. In particular, some individuals may interpret a CVT transmission as being underpowered or slow. Moreover, CVT transmissions may be paired with relatively small displacement engines, which may also add to the general feeling of an underpowered powertrain.

In one approach to enhance the sound quality and feel, a CVT transmission may be detuned to mimic the sound quality of a fixed gear transmission. That is, the CVT transmission may be calibrated to vary the engine speed to imitate the shifting that is created by a fixed gear ration transmission. However, this approach generally results in reduced efficiency and fuel economy. Accordingly, it is desirable to provide a CVT transmission having improved sound quality without reducing efficiency.

### SUMMARY OF THE INVENTION

In one exemplary embodiment of the invention, a control system for a vehicle is provided. The vehicle has a continuously variable transmission (“CVT”), an engine, and a speaker. The control system includes a vehicle bus, a shifting module, and an engine sound enhancement (“ESE”) module. The vehicle bus transmits a signal. The signal indicates a plurality of operating conditions of the vehicle. The shifting module receives the signal from the vehicle bus. The shifting module determines if the plurality of operating parameters of the vehicle indicate that the speaker is required to emit an audio signal that is blended with an engine sound emitted from the engine to mimic a shifting sound that a theoretical fixed gear transmission makes while shifting gears. The shifting module generates a shift mode signal if the speaker is required to emit the audio signal. The engine sound enhancement (“ESE”) module receives the shift mode signal. The ESE module receives a plurality of engine order equations. The ESE module actuates at least one of the engine order equations if the shift mode signal is received. In one embodiment the ESE module may also augment a natural engine order sound if the shift mode signal is received.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic diagram of an exemplary control system in a vehicle;

FIG. 2 is a dataflow diagram of a control module shown in FIG. 1; and

FIG. 3 is an illustration of an exemplary sound graph illustrating operation of the control system shown in FIG. 1.

### DESCRIPTION OF THE EMBODIMENTS

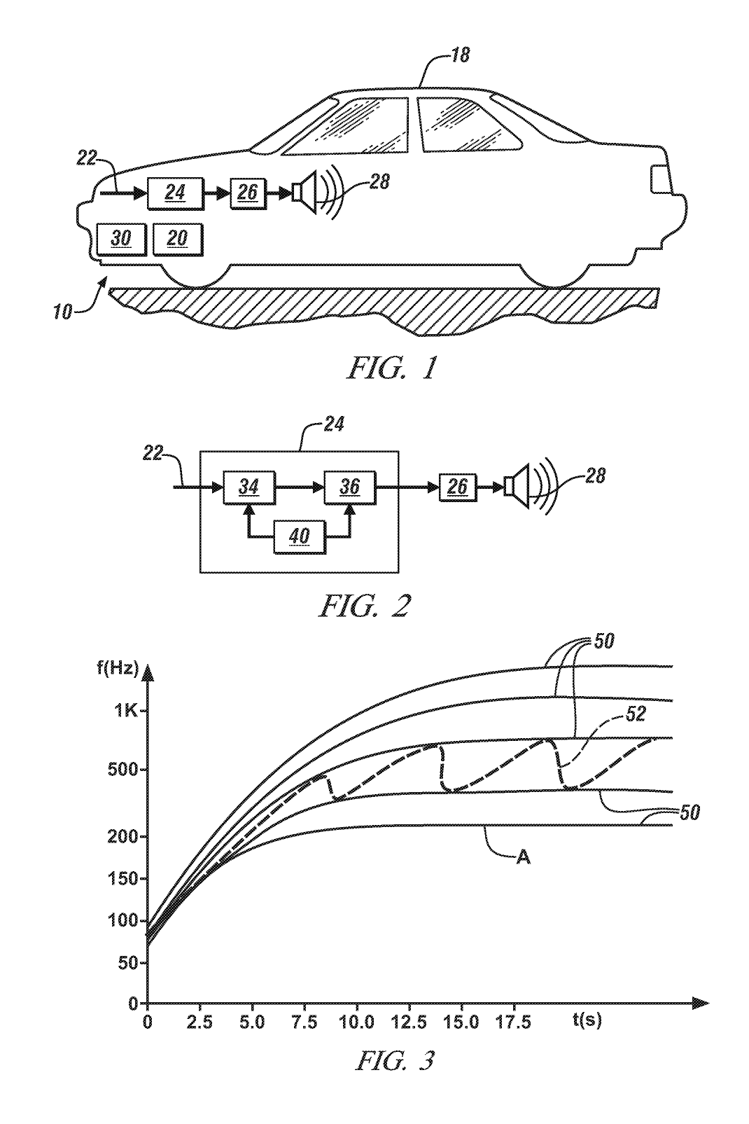

Referring now to FIG. 1, an exemplary embodiment is directed to a control system 10 for providing engine sound enhancement for a vehicle 18. The control system 10 includes a continuously variable transmission (“CVT”) 20, a vehicle bus 22, a control module 24, an amplifier 26, and a speaker 28. The control system 10 is configured for enhancing specific tones or sounds that are emitted by an engine 30 based on various operating parameters of the vehicle 18. The CVT 20 is generally any type of transmission that continuously varies the gear ratios depending on the operating conditions of the vehicle 18. The vehicle bus 22 is in communication with various control modules (not illustrated) of the vehicle 18.

The vehicle bus 22 transfers data between various vehicle control modules (not shown) indicating operating parameters of the vehicle 18. For example, the vehicle bus 22 may be in communication with an engine control module (not shown) of the engine 30 to receive a signal indicating vehicle speed, engine speed, engine torque, throttle pedal position, and vehicle acceleration. In another example, the vehicle bus 22 may also be in communication with a transmission control module (not shown) to receive a signal indicating a transmission state of the CVT 20. The transmission state refers to a position of a shift lever (not shown) of the vehicle 18, such as a park “P” position, a reverse “R” position, a sport “S” position or a drive “D” position. The vehicle bus 22 may also contain other operating parameters of the vehicle 18 as well such as, for example, a vehicle selected mode and accelerator pedal (not shown) position dynamics as well.

The vehicle selected mode refers to a selectable driving mode of the vehicle 18. When selected, the vehicle selected mode will modify various systems of the vehicle 18 such as, for example, a vehicle steering system (not shown), a vehicle suspension (not shown), a vehicle audio system (e.g., which includes the speaker 28), and the CVT 20. Some examples of a vehicle selected mode include, but are not limited to, Race, Normal, Stealth, City, Sport (which in turn will include various levels of the Sport mode of the vehicle 18), and Economy. For example, in Economy mode various operating parameters of the vehicle 18 are modified to improve fuel economy. In another example, in Sport mode various operating parameters of the vehicle 18 are modified to enhance acceleration and overall vehicle performance. Some examples of vehicle systems that may be affected include, but are not limited to, a steering system, an exhaust system, and vehicle suspension. The Sport mode may also include various levels of enhanced vehicle performance (which is sometimes referred to as sportiness) as well.

The control module 24 is in communication with the vehicle bus 22 and the amplifier 26. The amplifier 26 receives a control signal from the control module 24. The amplifier 26 converts the control signal to an electrical signal that is used to drive the speaker 28. Although FIG. 1 illustrates the control module 24 and the amplifier 26 as separate components, it is understood that the control module 24 and the amplifier 26 may be integrated into a single unit as well. The speaker 28 is configured for emitting an audio signal that combines or blends with the tones that are emitted from the engine 30, an exhaust gas system (not illustrated), and an air induction system (not shown) of the vehicle 18. In one exemplary embodiment, the speaker 28 may be part of an infotainment system of the vehicle 18.

Referring now to FIG. 2, a dataflow diagram illustrates an exemplary embodiment of the control module 24 of FIG. 1. In various embodiments, the control module 24 may include one or more sub-modules and datastores. As used herein the terms module and sub-module refer to an application specific integrated circuit (ASIC), an electronic circuit, a processor (shared, dedicated, or group) and memory that executes one or more software or firmware programs, a combinational logic circuit, and/or other suitable components that provide the described functionality. As can be appreciated, the sub-modules shown in FIG. 2 can be combined and/or further partitioned.

In one example, the control module 24 includes a shift determination module 34 and an engine sound enhancement (“ESE”) module 36. The shift determination module 34 receives a data signal as input from the vehicle bus 22. The data signal includes a plurality of operating parameters of the vehicle 18. The control module 24 also includes a memory 40. The memory 40 includes parameters relating to a theoretical fixed gear transmission. That is, the memory 40 stores operating parameters of a fixed gear transmission that is not part of the vehicle 18. Specifically, the theoretical fixed gear transmission may be any type of fixed gear transmission that upshifts from a lower gear to a higher gear based on operating conditions of a theoretical vehicle, or downshifts from a higher gear to a lower gear. For example, in one embodiment the theoretical fixed gear transmission may be a six-speed automatic transmission.

The shifting module 34 includes control logic for determining if the plurality of operating parameters received from the vehicle bus 22 indicates that the speaker 28 is required to emit an audio signal that is blended with an engine sound emitted by the engine 30 to mimic a shifting sound that the theoretical fixed gear transmission would create if shifting gears. The shifting sound that is created may enhance the driving experience of the vehicle occupants, as some individuals prefer the sound quality of a fixed gear transmission when compared to a CVT. Specifically, based on the operating parameters of the vehicle 18 (for example, vehicle speed, engine speed, engine torque, and a transmission state of the CVT 20), sometimes the vehicle occupants may prefer to hear the sound of a fixed gear transmission shifting.

In one exemplary embodiment, the shifting module 34 includes logic determining if the theoretical fixed gear transmission would upshift gears (e.g., between second gear to third gear, or from third gear to fourth gear) based on at least the engine speed, engine torque, and the transmission state of the CVT 20. That is, the theoretical fixed gear transmission would only upshift gears if the transmission state indicates a shift lever (not shown) of the vehicle 18 is in the “D” position, or the sport position “S”. In one embodiment, the shifting module 34 may also determine if the theoretical fixed gear transmission would upshift gears based on an additional number of operating parameters as well. Specifically, for example, the additional operating parameters include, but are not limited to, the vehicle speed, vehicle selected mode, accelerator pedal dynamics (e.g., the velocity or acceleration of the pedal), and vehicle acceleration.

In another embodiment, the shifting module 34 may determine if the operating parameters of the vehicle 18 (for example, the accelerator position, vehicle acceleration, and/or the activation of Sport mode) indicate an aggressive or powerful driving condition, where the shifting sound would be needed. Some examples of the aggressive or powerful driving include, but are not limited to, a relatively rapid acceleration of the vehicle 18 from a stoplight, or passing another vehicle on a two-lane road. These types of aggressive or powerful driving conditions indicate an enhanced emotional state of a driver, where the driving experience of the driver and vehicle occupants would be enhanced by a shifting sound. The powerful driving condition usually indicates that a driver would expect to hear a shifting sound. In one embodiment, the powerful driving condition may indicate a more aggressive shifting schedule of the theoretical fixed gear transmission is needed. That is, if the aggressive driving condition is determined by the shifting module 34, then the shifting module 34 may utilize a more aggressive shift schedule of the theoretical fixed gear transmission.

If the shifting module 34 determines that the speaker 28 is required to emit the audio signal, then the shifting module 34 generates a shift mode signal. The shifting module 34 is in communication with and sends the shift mode signal to the ESE module 36. In one exemplary embodiment, the shifting signal may only be sent by the shifting module 34 to the ESE module 36 if the vehicle selected mode received from the vehicle bus 22 indicates that the vehicle 18 is operating in Sport mode.

The ESE module 36 also receives a plurality of engine order equations from the memory 40 as well. The engine order equations each correspond to a rotational frequency of a crankshaft (not shown) of the engine 30 (shown in FIG. 1). The engine order equations may be unique to a specific powertrain as well as the type of vehicle (e.g., sporty car, midsize sedan, etc.). Specifically, in one exemplary embodiment, the engine order equations may depend on the number of cylinders of the engine 30, engine displacement, engine aspiration (e.g., normally aspirated versus forced induction), engine calibration, and an exhaust gas system (not shown) of the vehicle 18. Each engine order produces a higher frequency tone.

For example, referring to FIG. 3, an exemplary sound graph is illustrated during operation of the vehicle 18, where the CVT 20 is operating. The x-axis represents time (in seconds) and the y-axis represents frequency (in Hertz). A plurality of engine orders 50 are illustrated. Specifically, in the example as shown, the sound graph illustrates engine orders 50. An engine base order ‘A’ is illustrated that levels out at about 200 Hertz.

Turning back to FIG. 2, the ESE module 36 includes control logic for enhancing or actuating at least one of the engine orders 50 if the shift mode signal from the shifting module 34 is received. Specifically, the ESE module 36 includes control logic for actuating at least one of the engine order equations to mimic a sound of the theoretical fixed gear transmission shifting gears. For example, if the vehicle speed, the engine speed, the engine torque, and the transmission state of the CVT 20 (shown in FIG. 1) indicate that the speaker 28 is required to emit the audio signal that would blend with the engine sound from the engine 30 to mimic the theoretical fixed gear transmission upshifting from third gear to fourth gear, then the ESE module 36 would actuate the engine order equations to mimic the sound of the theoretical fixed gear transmission upshifting from second gear to third gear. Specifically, referring back to FIG. 3, the ESE module 36 creates a plurality of ESE tones (where only one ESE tone 52 is illustrated for purposes of clarity) that are superimposed on the engine orders 50. The ESE tones 52 imitate or mimic a shifting sound that the theoretical fixed gear transmission would create while shifting gears.

The ESE module 36 may also include control logic for augmenting a natural engine order sound as well. Specifically, the base order A is created naturally by the engine 30 (FIG. 1). In order to allow for blending of the ESE tones 52 generated by the ESE module 36 (FIG. 2), the base order created by the engine 30 may be decreased. This in turn allows for the ESE tones 52 that emulate the shifting sound to stand out more cleanly from the base order sound. In one approach, active noise control (“ANC”) may be used to cancel base orders.

The ESE module 36 sends a control signal to the amplifier 26. The amplifier 26 converts the control signal to an electrical signal that is used to drive the speaker 28. The speaker 28 emits an audio signal that combines with the sound emitted from the engine 30 (FIG. 1). Specifically, the audio signal emitted from the speaker 28 is blended with the sound emitted from the engine 30 to mimic the sound that the fixed gear transmission would create if shifting gears. Referring now to both FIGS. 2-3, the ESE module 36 creates the ESE tones 52 that mimic the sound of a fixed gear transmission. Some individuals prefer the sound quality of a fixed gear transmission. The ESE tones 52 create the sound quality of a fixed gear transmission without detuning the CVT 20, which in turn may reduce fuel economy and cause the vehicle 18 to accelerate at a slower rate. Thus, the control system 10 as described above provides enhanced sound quality to the occupants of an interior cabin of the vehicle 18. At the same time, the control system 10 does not increase or modify the level of sound that is emitted from the vehicle 18 into the external environment.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed:

1. A control system for a vehicle, the vehicle having a continuously variable transmission (“CVT”), an engine, and a speaker, comprising:
a vehicle bus transmitting a signal, the signal indicating a plurality of operating conditions of the vehicle;
a shifting module for receiving the signal from the vehicle bus, the shifting module determining if the plurality of operating parameters of the vehicle indicate that the speaker is required to emit an audio signal, wherein the audio signal is blended with an engine sound emitted from the engine to mimic a shifting sound that a theoretical fixed gear transmission creates while shifting gears, the shifting module generating a shift mode signal if the speaker is required to emit the audio signal; and
an engine sound enhancement (“ESE”) module for receiving the shift mode signal and a plurality of engine order equations, the ESE module actuating at least one of the plurality of engine order equations if the shift mode signal is received.

2. The control system as recited in claim 1, wherein the plurality of operating parameters are a combination of a vehicle speed, an engine speed, an engine torque, and a transmission state of the CVT.

3. The control system as recited in claim 2, wherein the shifting module generates the shift mode signal if the transmission state indicates a shift lever is in a drive position.

4. The control system as recited in claim 2, wherein the plurality of operating parameters further include at least one of a vehicle selected mode, an accelerator pedal velocity, an accelerator pedal acceleration, and a vehicle acceleration.

5. The control system as recited in claim 4, wherein the shifting module generates the shift mode signal if the vehicle selected mode is selected to a Sport mode.

6. The control system as recited in claim 1, wherein the ESE module actuates at least one of the plurality of engine order equations by superimposing as least one ESE tone on at least one of a plurality of engine orders, wherein the at least one ESE tone mimics the shifting sound that the theoretical fixed gear transmission creates while shifting gears.

7. The control system as recited in claim 1, wherein the ESE module is in communication with an amplifier, and wherein the amplifier is in communication with the speaker.

8. The control system as recited in claim 1, comprising an amplifier, wherein the shifting module and the ESE module are integrated with the amplifier, and wherein the amplifier is in communication with the speaker.

9. The control system as recited in claim 1, wherein the engine order equations are dependent on a combination of a number of cylinders of an engine of the vehicle, an engine displacement, an engine aspiration, an engine calibration, an engine induction system, and an exhaust gas system of the vehicle.

10. The control system as recited in claim 1, wherein the shifting module determines if the plurality of operating parameters indicate a powerful driving condition is taking place.

11. The control system as recited in claim 1, wherein the ESE module includes control logic for augmenting a natural engine order sound.

12. A vehicle, comprising:
a continuously variable transmission (“CVT”);
an engine;
a speaker;
a vehicle bus transmitting a signal, the signal indicating a plurality of operating conditions of the vehicle, the plurality of operating parameters being combination of a vehicle speed, an engine speed, an engine torque, and a transmission state of the CVT;
a shifting module for receiving the signal from the vehicle bus, the shifting module determining if the plurality of operating parameters of the vehicle indicate that the speaker is required to emit an audio signal, wherein the audio signal is blended with an engine sound emitted from the engine to mimic a shifting sound that a theoretical fixed gear transmission creates while shifting gears, the shifting module generating a shift mode signal if the speaker is required to emit the audio signal; and
an engine sound enhancement (“ESE”) module for receiving the shift mode signal and a plurality of engine order equations, the ESE module actuating at least one of the plurality of engine order equations if the shift mode signal is received.

13. The vehicle as recited in claim 12, wherein the plurality of operating parameters further include at least one of a vehicle selected mode, an accelerator pedal velocity, an accelerator pedal acceleration, and a vehicle acceleration.

14. The vehicle as recited in claim 13, wherein the shifting module generates the shift mode signal if the vehicle selected mode is selected to a Sport mode.

15. The vehicle as recited in claim 12, wherein the ESE module actuates at least one of the plurality of engine order equations by superimposing as least one ESE tone on at least one of a plurality of engine orders, wherein the at least one ESE tone mimics the shifting sound that the theoretical fixed gear transmission creates while shifting gears.

16. The vehicle as recited in claim 12, wherein the ESE module is in communication with an amplifier, and wherein the amplifier is in communication with the speaker.

17. The vehicle as recited in claim 12, comprising an amplifier, wherein the shifting module and the ESE module are integrated with the amplifier, and wherein the amplifier is in communication with the speaker.

18. The vehicle as recited in claim 12, wherein the engine order equations are dependent on a combination of a number of cylinders of an engine of the vehicle, an engine displacement, an engine aspiration, an engine calibration, an engine induction system, and an exhaust gas system of the vehicle.

19. The vehicle as recited in claim 12, wherein the shifting module generates the shift mode signal if the transmission state indicates a shift lever is in a drive position.

20. A vehicle, comprising:
a continuously variable transmission (“CVT”);
an engine;
a speaker;
a vehicle bus transmitting a signal, the signal indicating a plurality of operating conditions of the vehicle, the plurality of operating parameters being a combination of a vehicle speed, an engine speed, an engine torque, and a transmission state of the CVT;
a shifting module for receiving the signal from the vehicle bus, the shifting module determining if the plurality of operating parameters of the vehicle indicate that the speaker is required to emit an audio signal, wherein the audio signal is blended with an engine sound emitted from the engine to mimic a shifting sound that a theoretical fixed gear transmission creates while shifting gears, the shifting module generating a shift mode signal if the speaker is required to emit the audio signal; and
an engine sound enhancement (“ESE”) module for receiving the shift mode signal and a plurality of engine order equations, the ESE module actuates at least one of the plurality of engine order equations by superimposing as least one ESE tone on at least one of a plurality of engine orders if the shift mode signal is received, wherein the at least one ESE tone mimics the shifting sound that the theoretical fixed gear transmission creates while shifting gears.
